(19) United States
(12) Patent Application Publication
(10) Pub. No.: US 2008/0231164 A1
(43) Pub. Date: Sep. 25, 2008

(54) Flat display panel and method of driving the same

(76) Inventors: Myoung-Sup Kim, Suwon-si (KR); Jeong-Nam Kim, Suwon-si (KR); Hyea-Weon Shin, Suwon-si (KR); Jae-Yong Lim, Suwon-si (KR); Won-Seok Yoon, Suwon-si (KR); Tae-Jung Chang, Suwon-si (KR)

Correspondence Address: ROBERT E. BUSHNELL, 1522 K STREET NW, SUITE 300, WASHINGTON, DC, 20005-1202, US

(21) Appl. No.: 12/076,646

(22) Filed: Mar. 20, 2008

(30) Foreign Application Priority Data
Mar. 20, 2007 (KR) 10-2007-0027244

(51) Int. Cl. H01J 17/49; G09G 3/288

(52) U.S. Cl. 313/491; 315/111.91

(57) ABSTRACT

A flat display panel in which a field emission principle of ferroelectrics is applied to improve the luminous efficiency with a low driving voltage, and a method of driving the same. The flat display panel includes a first substrate and a second substrate which face each other, barrier ribs which are disposed between the first and second substrates and partition a space between the first and second substrates into a plurality of display cells, a ferroelectric layer which is disposed to face the display cells and is formed of a ferroelectric material that is to be dielectric-polarized according to an external electric field, a first electrode and a third electrode to which electric fields having different opposite polarities are sequentially applied and which induces polarization inversion in the ferroelectric layer placed between the first and third electrodes so that the ferroelectric layer emits electron beams into the display cells, an excitation gas filled in the display cells to be excited by the electron beams, and a phosphor layer formed in the display cells.

### CLAIM OF PRIORITY

This application makes reference to, incorporates the same herein, and claims all benefits accruing under 35 U.S.C. § 119 from an application for FLAT DISPLAY PANEL AND METHOD OF DRIVING THE SAME earlier filed in the Korean Intellectual Property Office on 20 Mar. 2007 and there duly assigned Serial No. 2007-0027244.

### BACKGROUND OF THE INVENTION

1. Field of the Invention

The present invention relates to a flat display panel and a method of driving the same, and more particularly, to a flat display panel in which a field emission principle of ferroelectrics is applied to improve luminous efficiency with a low driving voltage, and a method of driving the same.

2. Description of the Related Art

Plasma display panels (PDP), which are a type of flat display panels, are display devices that form an image using electrical discharge and have excellent brightness, view angle or display performance. Thus, the usage of a PDP has been remarkably increased. That is, in the PDP, a direct current (DC) or an alternating current (AC) voltage is applied to electrodes, a gas charge occurs between the electrodes due to a voltage that is applied to the electrodes, a phosphor layer that is formed in a predetermined pattern is excited by ultraviolet rays generated in a discharge process, and thus, visible rays are emitted.

A contemporary PDP includes a first and second substrates which face each other and are spaced apart from each other by a predetermined distance, and barrier ribs which are disposed between the first and second substrates and partition a space between the first and second substrates into a plurality of display cells. A pair of discharge sustain electrodes which causes a sustain discharge, and a dielectric layer, which buries the pair of discharge sustain electrodes, are disposed on one side of second substrate, this side facing first substrate. In addition, an address electrode, which causes an auxiliary discharge with one of discharge sustain electrode of the pair of the discharge sustain electrodes, is disposed on one side of the first substrate, this side facing the second substrate, and address electrode is buried by a lower dielectric layer. Also, a discharge gas is filled in the space of the display cells.

When the discharge gas is ionized between the pair of discharge sustain electrodes to which an AC voltage, having a higher value than a value of a discharge firing voltage, is applied, a plasma discharge is performed. Gas particles excited as a result of discharge are stabilized again and ultraviolet (UV) rays are generated. Then, the UV rays are changed into visible rays by a phosphor layer applied to inner walls of the display cells, and the visible rays are emitted through second substrate so that a predetermined image which a user can perceive can be realized.

Such a plasma discharge is also applied to a flat lamp that is used as a backlight for a liquid crystal display (LCD). The PDP and flat lamp, however, require a high energy to ionize a discharge gas so as to cause a discharge, and in return, the required driving voltage increases and luminous efficiency is degraded.

### SUMMARY OF THE INVENTION

It is therefore one object of the present invention to provide an improved flat display panel and an improved method of driving the same to overcome the disadvantage stated above.

It is another object of the present invention to provide a flat display panel in which a field emission principle of ferroelectrics is applied to improve luminous efficiency with a low driving voltage, and a method of driving the same.

According to an aspect of the present invention, there is provided a flat display panel including a first substrate and a second substrate facing each other; barrier ribs which are disposed between the first and second substrates and partition a space between the first and second substrates into a plurality of display cells; a ferroelectric layer which is disposed to face the display cells and is formed of a ferroelectric material that is to be dielectric-polarized according to an external electric field; a first electrode and a third electrode to which electric fields having opposite polarities are sequentially applied and which induces polarization inversion in the ferroelectric layer placed between the first and third electrodes so that the ferroelectric layer emits electron beams into the display cells; an excitation gas filled in the display cells that is to be excited by the electron beams; and a phosphor layer formed in the display cells.

The ferroelectric layer may be supported inside of the first substrate.

The first and third electrodes may be disposed on the opposite faces of the ferroelectric layer, respectively.

The first and third electrodes may extend in a direction in which the first and third electrodes cross one another. In each display cell, one first electrode and a pair of third electrodes may cross one another.

The pair of third electrodes may extend in parallel and may be separated apart by a predetermined distance so that the ferroelectric layer may be exposed between the pair of the third electrodes in the discharge cells. In each display cell, one first electrode and one third electrode may cross each other. Alternatively, a plurality of electrode windows or a plurality of opening holes may be formed in portions of the third electrode that crosses the first electrode. The electrode windows may extend in a lengthwise direction of the third electrode.

The ferroelectric layer may be disposed inside of the first substrate, and a second electrode that forms an acceleration electric field may be disposed inside of the second substrate to accelerate electrons emitted from the ferroelectric layer.

Electrons emitted from the ferroelectric layer may have an energy level that is lager than an energy needed to excite the excitation gas and lower than an energy needed to ionize the excitation gas.

The phosphor layer may be supported by being disposed on the second substrate.

The second electrode, for accelerating electrons emitted from the ferroelectric layer, may be disposed inside of the second substrate and the phosphor layer may be disposed to cover the second electrode.

The excitation gas may include xenon (Xe).

According to another aspect of the present invention, there is provided a method of driving the flat display panel including applying a positive (+) electric field and a negative (−) electric field to the first electrode and the third electrode, respectively, to induce dielectric polarization in the ferroelectric layer and to accumulate field-emitted electrons on the surface of the ferroelectric layer; and applying an electric field, having an opposite polarity to a polarity used in the accumulating of the electrons, between the first electrode and the third electrode so as to induce polarization inversion in the ferroelectric layer and to emit electrons accumulated on the surface of the ferroelectric layer into the display cells.

The method may farther include removing the electric fields applied to the first electrode and the third electrode and sustaining electrons accumulated by the remaining polarization of the ferroelectric layer, between the accumulating of the electrons and the emitting of the electrons.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a cross-sectional view of a structure of a contemporary plasma display panel (PDP).

FIG. 2 is an exploded perspective view of a flat display panel constructed according to an embodiment of the present invention.

FIG. 3 is a vertical cross-sectional view of the flat display panel illustrated in FIG. 2 taken along line III-III.

FIG. 4 is a two-dimensional coordinate illustrating an energy level of xenon (Xe) included in a discharge gas.

FIGS. 5A through 5C illustrate electron accumulation and electron emission principles of using a ferroelectric layer, by illustrating an electron accumulation operation, an electron sustain operation, and an electron emission operation, respectively.

FIGS. 6 through 8 are exploded perspective views of flat display panels constructed according to other embodiments of the present invention.

### DETAILED DESCRIPTION OF THE INVENTION

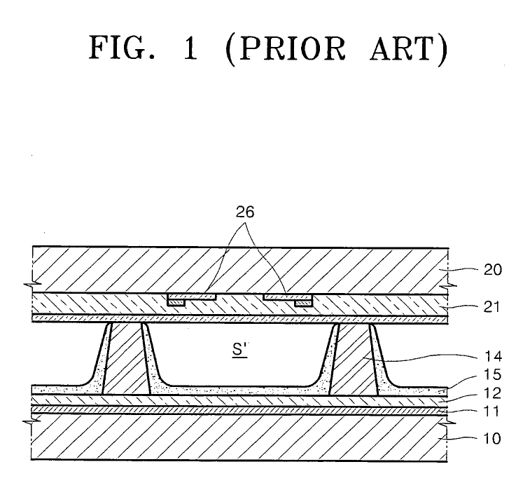

Now turning to FIG. 1, FIG. 1 shows a cross-sectional view of a structure of a contemporary plasma display panel (PDP).

FIG. 1 illustrates a cross-sectional view of a structure of a contemporary PDP. Referring to FIG. 1, a contemporary PDP includes first and second substrates 10 and 20 which face each other, and barrier ribs 14 which are disposed between a first and second substrate 10 and 20 and partition a space between first and second substrates 10 and 20 into a plurality of display cells S′. A pair of discharge sustain electrodes 26 which causes a sustain discharge, and a dielectric layer 21, which buries the pair of discharge sustain electrodes 26, are disposed on one side of second substrate 20, this side facing first substrate 10. In addition, an address electrode 11, which causes an auxiliary discharge with one of discharge sustain electrode 26 of the pair of discharge sustain electrodes 26, is disposed on one side of first substrate 10, this side facing second substrate 20, and address electrode 11 is buried by a lower dielectric layer 12. Also, a discharge gas (not shown) is filled in the space of display cells S′.

When the discharge gas is ionized between the pair of discharge sustain electrodes 26 to which an AC voltage, having a higher value than a value of a discharge firing voltage, is applied, a plasma discharge is performed. Gas particles excited as a result of discharge are stabilized again and ultraviolet (UV) rays are generated. Then, the UV rays are changed into visible rays by a phosphor layer 15 applied to inner walls of display cells S′, and the visible rays are emitted through second substrate 20 so that a predetermined image which a user can perceive can be realized.

Such a plasma discharge is also applied to a flat lamp that is used as a backlight for a liquid crystal display (LCD). The PDP and flat lamp, however, require a high energy to ionize a discharge gas so as to cause a discharge, and in return, the required driving voltage increases and luminous efficiency is degraded.

The present invention will now be described more fully with reference to the accompanying drawings, in which exemplary embodiments of the invention are shown.

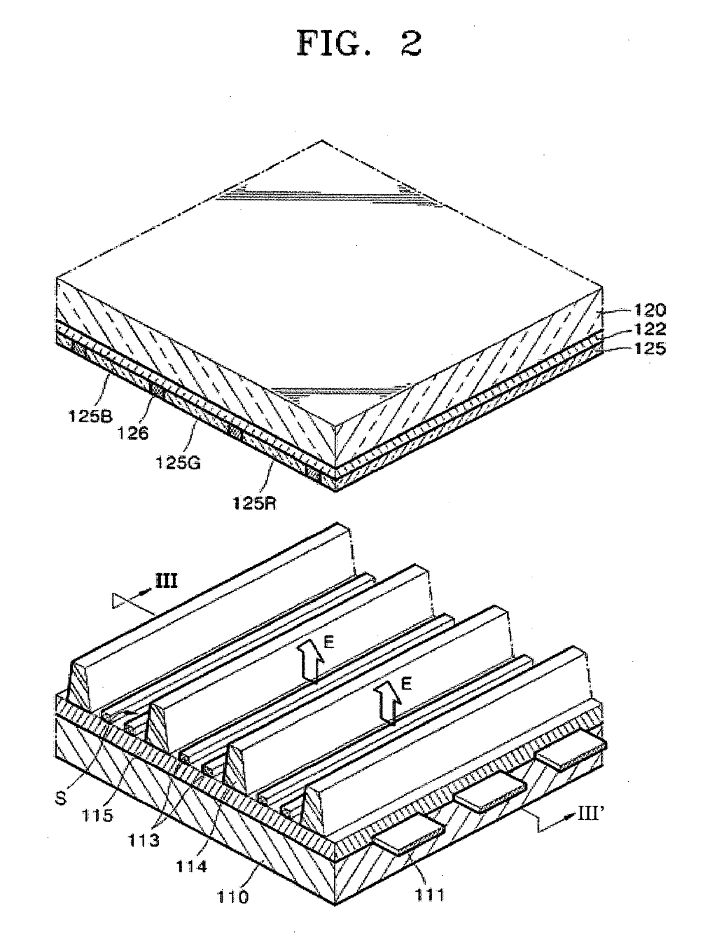

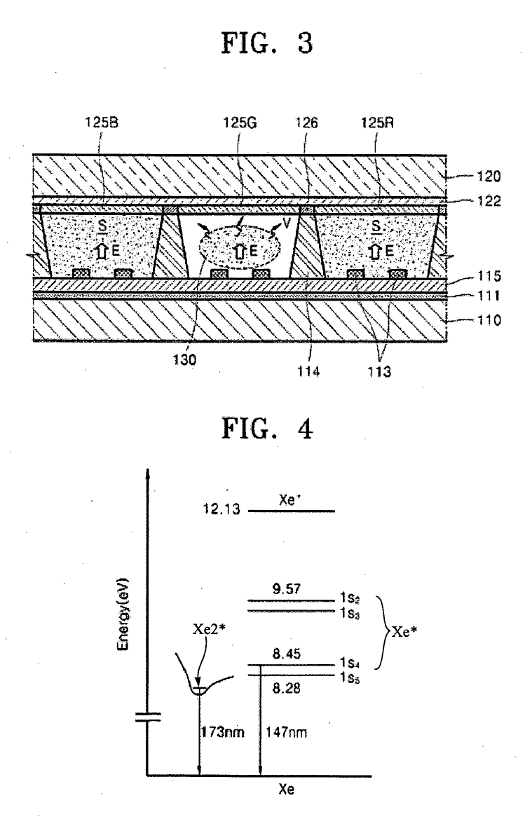

FIG. 2 is an exploded perspective view of a flat display panel according to an embodiment of the present invention, and FIG. 3 is a vertical cross-sectional view of the flat display panel illustrated in FIG. 2 taken along line III-III′.

As illustrated in FIG. 2, a flat display panel includes first and second substrates 110 and 120 which face each other and are spaced apart from each other by a predetermined distance, and barrier ribs 114 which partition a space between first and second substrates 110 and 120 into a plurality of display cells S together with the first and second substrates 110 and 120. Also, first and second substrates 110 and 120 may be glass substrates. Barrier ribs 114 also prevent electrical, optical interferences between display cells S to constitute independent emission regions. In the present embodiment, barrier ribs 114 are formed in open type stripe patterns viewed along the extending direction of barrier ribs 14. The present invention, however, is not limited thereto, and thus, various barrier patterns including closed type matrix patterns may be used.

A plurality of first electrodes 111 are disposed on first substrate 110 to extend in parallel along the direction perpendicular to extending direction of barrier ribs 14, and one of the first electrodes 111 may be disposed in a display cell S. A ferroelectric layer 115 is disposed on top of first electrode 111 to bury first electrode 111. Here, since a ferroelectric that is used as a material of a ferroelectric layer must have a ferroelectric property at the room temperature, ferroelectric layer 115 may be formed of a ferroelectric in which a transition temperature between the ferroelectric and a paraelectric is higher than the room temperature, such as (Pb,La)—(ZrTi)O₃,(Pb,Bi)—(ZrTi)O₃,(Pb,La)—(HfTi)O₃,(Pb,Ba)—(ZrTi)O₃, (Pb,Sr)—(ZrTi)O₃,LiTaO₃,SrTiO₃,La₂Ti₂O₇,LiNbO₃,(Pb,La)—(MgNbZrTi)O₃,(Pb,Ba)—(LaNb)O₃,(Sr Ba)—Nb₂O₃,K(Ta,Nb)O₃,(Sr,Ba,La)—(Nb₃O₆),NaTiO₃,MgTiO₃,BaTiO₃,SrZrO₃, and KNbO₃.

A plurality of third electrodes 113 are disposed on ferroelectric layer 115 to extend in parallel to a direction in which third electrodes 113 cross first electrodes 111, and a pair of third electrodes 113 may be disposed within each display cell S, extend in parallel and are separated apart from each other by a predetermined distance. In other words, a region in which one of first electrodes 111 and one of the pairs of third electrodes 113 cross one another constitutes one display cell S, and thus, electron beams E are emitted in a portion in which first electrode 111 and the pair of third electrodes 113, and ferroelectric layer 115 overlap one another, so that emission is performed. A common driving voltage is applied to the pair of third electrodes 113. The pair of third electrodes 113 may be electrically connected to one another at their ends. In the embodiment as shown in FIG. 2, one of first electrodes 111 and one of the pairs of third electrodes 113 cross one another in one display cell S. The present invention is not limited thereto, and thus, display cell S may be formed such that only one of first electrodes 111 crosses with one of third electrode 113.

The arrangement structure in that first and third electrodes 111 and 113 that cross one another enables passive matrix (PM) driving of a display panel. In the PM driving method, an on/off state of all of display cells S should be controlled at one time, unlike an active matrix (AM) driving method in which a control element, i.e., thin film transistor (TFT), should be provided in each display cell S so as to separately control the on/off states of each display cell S. Thus, the PM driving method is advantageous in the simplified construction and driving method.

Due to the material characteristic of ferroelectric layer 115, dielectric polarization is induced in ferroelectric layer 115 according to electrical polarities of first and third electrodes 111 and 113 that are in contact with ferroelectric layer 115. As such, a high electric field is concentrated between the exposed surface of ferroelectric layer 115 and third electrodes 113 that contacts ferroelectric layer 115 so that field-emitted electrons are accumulated on the surface of ferroelectric layer 115. After that, if the polarities of first and third electrodes 111 and 113 are inverted, polarization inversion is induced in ferroelectric layer 115 and the electrons that were accumulated on the surface of ferroelectric layer 115 are emitted into display cell S due to an electrical repulsive force, and thus, the emitted electrons constitute one electron beam E. The principle of electron accumulation and emission will be described later in greater details. The energy level of the emitted electrons can be optimized due to a voltage that is applied between first and third electrodes 111 and 113. The energy level of the emitted electrons may be higher than the level of energy needed in exciting an excitation gas 130 and may be lower than the level of energy needed in ionizing excitation gas 130. In this case, predetermined ultraviolet (UV) rays, which are supplied to a phosphor layer 125 for light emission, may be provided through gas excitation, and thus, ineffective consumption of energy caused by unnecessary gas ionization may be reduced. In the present embodiment, first electrode 111 and third electrode 113 may be formed of a metallic electrode material having excellent electrical conductivity. In particular, third electrode 113 functions as a cathode electrode for providing emission electrons and thus may be formed of a metallic material having a small work function.

A second electrode 122 is disposed under second substrate 120, and second electrode 122 may be a common electrode that supplies the same voltage to all display cells S. For example, second electrode 122 may also be formed of indium tin oxide (ITO) which is a transparent electrode material, so that transmission of visible rays generated in display cells S is performed. Alternatively, second electrode 122 may also be a mesh type metallic electrode. Electrons, that are emitted into display cells S from the surface of ferroelectric layer 115 through polarization inversion induced by first and third electrodes 111 and 113, are accelerated toward second substrate 120, the second substrate 120 is positioned above ferroelectric layer 115, by an electric field between third electrodes 113 and second electrode 122, and excitation gas 130 that is filled in display cells S is excited due to collision with the accelerated electrons. Hence, an energy level of the emission electrons may be adjusted by adjusting the voltage that is applied between third and second electrodes 113 and 122. For example, by applying a high voltage between third and second electrodes 113 and 122, a discharge state in which excitation gas 130 is ionized may also be induced. In the embodiment of FIG. 2, second electrode 122 is a surface electrode that commonly functions in all of display cells S. The present invention, however, is not limited thereto, and thus, second electrode 122 may be a plurality of stripe electrodes that are arranged to be spaced apart from one another by a predetermined distance.

Second electrode 122 is covered by phosphor layer 125 that may include a red phosphor layer 125R, a green phosphor layer 125G, and a blue phosphor layer 125B constructed according to emission colors. The corresponding display cells S are classified into red emission display cells, green emission display cells, and blue emission display cells according to types of applied phosphor layers. Display cells S having different emission colors constitute one unit pixel. The UV rays excite phosphor layer 125 and visible rays having a peculiar color are emitted according to the types of phosphor such that the visible rays are emitted through second substrate 120 to constitute a predetermined image. Phosphor layer 125 having different emission colors may be classified by forming a black matrix 126 that may have dark color having an excellent light-absorbing rate so as to absorb external light and maintain a high contrast ratio. In addition, black matrix 126 may also prevent mixing of colors due to an optical interference between adjacent emission colors. Phosphor layer 125 may be formed at any place on inner walls that define display cells S. In order to increase an area in which phosphor layer 125 is to be applied, phosphor layer 125 may also be formed at sides of barrier ribs 114 together with the bottom surface of second substrate 120. Only when phosphor layer 125 is formed above first substrate 110, phosphor layer 125 may be applied in a limited manner in the range where emission of electron beams E is not interrupted.

Display cells S is usually filled with excitation gas 130 including xenon (Xe). Also, excitation gas 130 is transited into an excited state due to collision with the emission electrons, and an energy level of the emission electrons is lowered to a stable ground state from the excited state and UV rays are emitted having a wavelength corresponding to the energy difference. The emitted UV rays are converted into visible rays due to phosphor layer 125, and the visible rays are emitted, and a predetermined image which a user can perceive is realized.

An energy level of Xe which is a UV rays-generating source, is schematically shown in FIG. 4. Referring to FIG. 4, an energy of more than 12.13 eV is needed so as to ionize Xe, and an energy of more than 8.28 eV is needed so as to excite Xe. Specifically, the energies of 8.28 eV, 8.45 eV, and 9.57 eV are needed so as to excite Xe in states 1S₅, 1S₄, and 1S₂, respectively. When the unstable excited Xe* is stabilized to the original energy state, UV rays having wavelength of 147 nm (nanometer) may be generated. Xe* in the excited state and Xe in a base state collide with each other, and thus, eximer Xe2* is generated. Then, eximer Xe2* is stabilized and UV rays having wavelength of 173 nm are generated. As a result, an energy ranging from 8.28 eV to 12.13 eV is needed so as to excite Xe in order to obtain UV rays that are to be absorbed by a phosphor layer.

In the present embodiment, only a comparatively low energy ranging from 8.28 to 12.13 eV is needed so as to excite the gas particles. Thus, a PDP constructed to the present invention may be driven with a much lower driving voltage than that of a contemporary PDP in which a high energy of more than 12.13 eV is needed for ionization caused by a gas discharge, and the brightness of the PDP of the present embodiment may be equal to that of the contemporary PDP so that luminous efficiency may be improved.

In the present invention, all electrons for light-emission are supplied by ferroelectric layer 115 so that a plasma discharge does not occur and losses caused by gas ionization may be completely eliminated. In a modified structure of flat display panels of the present invention, however, when an opposite discharge is performed between first electrode 111 and second electrode 122 that are respectively disposed on substrates 110 and 120, excitation gas 130 is ionized and electrons are generated, and additional electrons are supplied by ferroelectric layer 115 so that a discharge firing voltage may be reduced and brightness may be improved. In this case, excitation gas 130 also functions as a discharge gas.

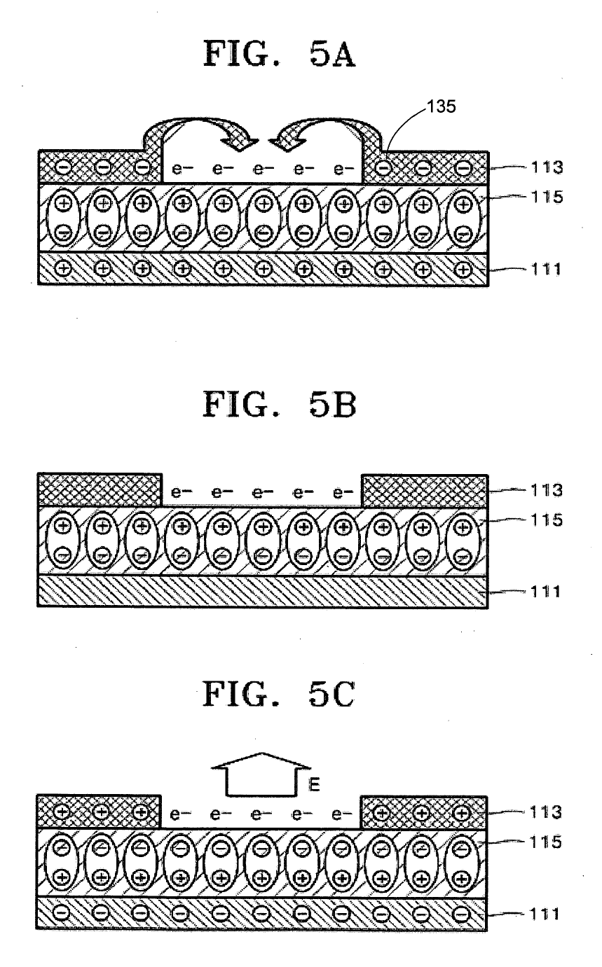

The principle of electron emission in the flat display panel will now be described with reference to FIGS. 5A through 5C. FIGS. 5A through 5C sequentially explain an electron accumulation operation, an electron sustain operation, and an electron emission operation, which are performed in a sequential order.

Referring to FIG. 5A, in the electron accumulation operation, a positive (+) electric field is applied to first electrode 111 and a negative (−) electric field is applied to third electrodes 113. Here, ferroelectric layer 115 that is formed between first and third electrodes 111 and 113 is polarized in a direction of an external electric field, and the surface of ferroelectric layer 115 physically contacting first electrode 111 has a negative (−) polarity, and the surface of ferroelectric layer 115 physically contacting third electrode 113 has a positive (+) polarity. Inside ferroelectric layer 115, opposite polarities of ferroelectric layer 115 are electrically neutralized, and thus, ferroelectric layer 115 does not have a polarity. In the present embodiment, an electric field is concentrated due to a negative (−) electric field of third electrodes 113 and a positive (+) electric field of the surface of ferroelectric layer 115 contacting third electrodes 113, electrons (e−) 135 are emitted from third electrodes 113, and emitted electrons (e−) 135 are accumulated on the exposed surface of ferroelectric layer 115.

Referring to FIG. 5B, in the electron sustain operation, even when electric fields of first and third electrodes 111 and 113 disappear, the electrons (e−), accumulated on the surface of ferroelectric layer 115, do not disappear but are sustained due to the remaining polarization, which is a feature of ferroelectrics. As will be described later, the flat display panel constructed according to the present invention may be driven in such a way that data setting and emission are sequentially performed using a memory effect of the ferroelectrics.

Referring to FIG. 5C, in the electron emission operation, an opposite electric field to an electric field in the initial electron accumulation operation is applied to first and third electrodes 111 and 113. In other words, when a negative (−) electric field is applied to first electrode 111 and a positive (+) electric field is applied to third electrodes 113, the surface of ferroelectric layer 115 that contacts first electrode 111 has a positive (+) polarity and the surface of ferroelectric layer 115 that contacts third electrode 113 has a negative (−) polarity due to a polarization inversion effect of ferroelectrics. Here, electrons (e−) that accumulated on the surface of ferroelectric layer 115 are emitted into display cells S due to an electrical repulsive force as defined by Coulomb's law. And the emission of accumulated electrons on the surface of ferroelectric layer 115 is marked as E on FIG. 5C. According to Coulomb's law, the magnitude of the electrostatic force between two point electric charges is directly proportional to the product of the magnitudes of each charge and inversely proportional to the square of the distance between the charges.

In exemplary driving of the flat display panel, display cells S in which light-emission will be performed are selected by performing a data setting operation, and then an electron emission operation in which electrons are supplied to display cells S has been performed. That is, in the data setting operation, in selected display cells S, electric fields are applied to first and third electrodes 111 and 113 to accumulate electrons, and in the unselected display cells S, electric fields are not applied to first and third electrodes 111 and 113. Then, if electric fields for electron emission are applied to first and third electrodes 111 and 113, in the selected display cells S, electrons (e−) that accumulated on the surface of ferroelectric layer 115 are emitted and light-emission is performed. On the other hand, in the unselected display cells S, the electrons (e−) are not accumulated and thus, light-emission is not performed.

As can be understood from an electron emission mechanism constructed according to the present invention, electron emission is concentrated in a region in which first and third electrodes 111 and 113 cross each other, and the electron emission mainly occurs at a portion of ferroelectric layer 115 near to and exposed from third electrodes 113 so that the electron emission is not interrupted. From this point of view, various modified structures of the electrode shapes related to the efficiency of electron emission need to be considered.

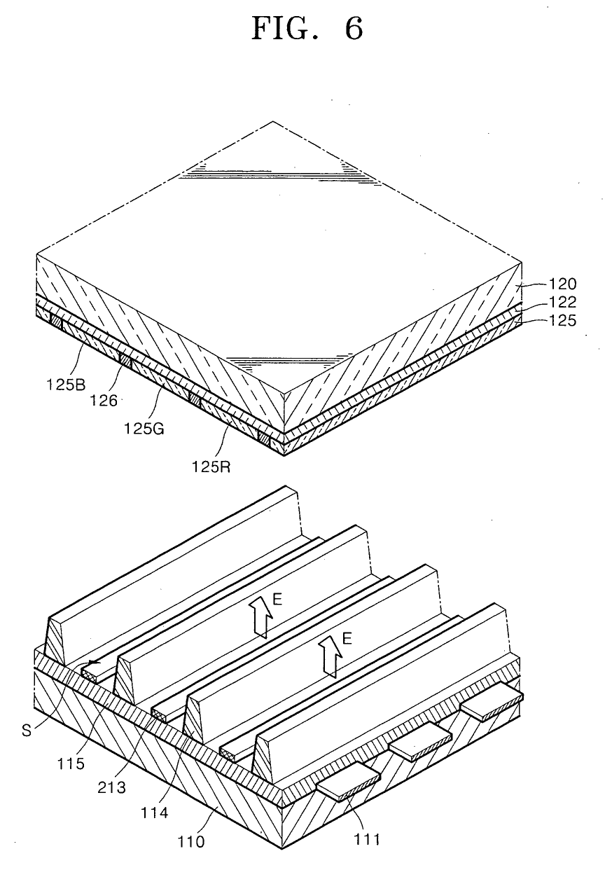

Modified structures of first and third electrodes 111 and 113 are shown in FIGS. 6 through 8. Referring to FIG. 6, first electrodes 111 and a third electrodes 213 are formed on first substrate 110 to extend in a direction in which first electrodes 111 and third electrodes 213 cross one another. A seat-shaped ferroelectric layer 115 is interposed between first and third electrodes 111 and 213. A region in which first and third electrodes 111 and 213 cross one another constitutes one emission unit and is partitioned into independent display cells S by barrier ribs 114 disposed on ferroelectric layer 115. In the present embodiment, barrier ribs 114 may have stripe patterns extended in one direction. Each display cell S is defined between the adjacent barrier ribs 114 in one direction, and in the other direction, display cells S may be defined up to a region which a sufficient electric field could reach so that, in that region, electron emission may be controlled by the identical first electrode 111. Each of first and third electrodes 111 and 213 is allocated to each display cell S, and a driving voltage, in which the polarities of first and third electrodes 111 and 213 are inverted, is applied to first and third electrodes 111 and 213 so that a corresponding display cell S is turned on into the state where a region in which first and third electrodes 111 and 213 cross one another is an emission center.

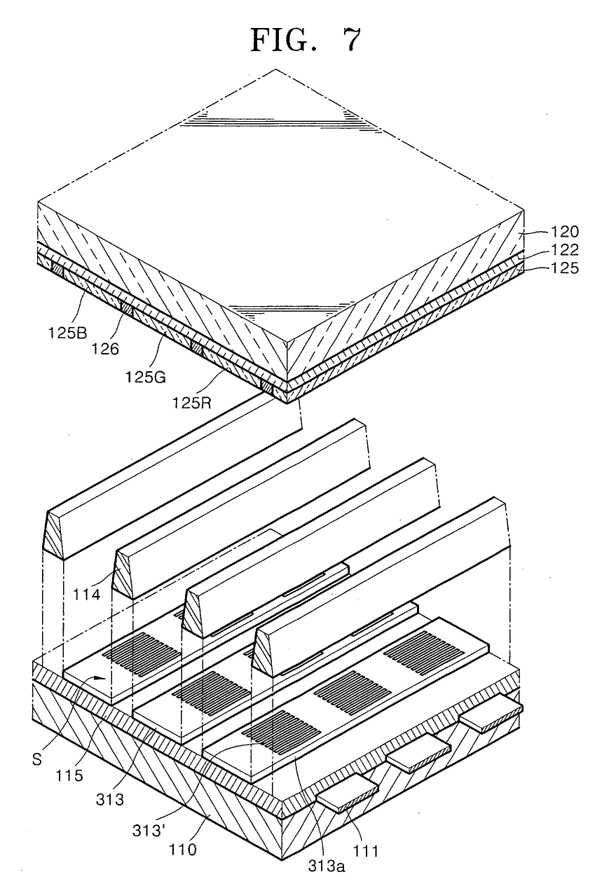

FIG. 7 shows another modified shape of an electrode structure that can be employed according to an embodiment of the present invention. Similar structure and functionality of the display panel as shown in FIGS. 2 and 6 will be omitted and only the difference will be described. Referring to FIG. 7, third electrodes 313 and first electrodes 111 are respectively disposed on the top surface and bottom surface of ferroelectric layer 115 placed on first substrate 110, and first and third electrodes 111 and 313 extend in two directions and first and third electrodes 111 and 313 cross one another. Each of third electrodes 313 has a plurality of striped portions 313a, on which electrode windows 313′ are formed, extending in a lengthwise direction therebetween. In other words, one of third electrode 313 has stripe portions 313a with electrode windows 313′ in a region in which third electrodes 313 cross first electrodes 111. Third electrodes 313 have a solid shape so as to maintain electrical conductivity in a region in which third electrodes 313 do not cross first electrodes 111.

Because striped portions 313a of third electrodes 313 have a relatively wider width comparing to third electrode as shown in FIGS. 2 and 6, ferroelectric layer 115 is activated in a wider region so that electron emission efficiency may be improved. In the present embodiment, striped portions 313a of third electrode 313 allow part of ferroelectric layer 115 to be exposed in display cells S through electrode windows 313′ so that electron emission may be performed. In details, stripped portions 313 a of third electrodes 313 are spaced apart from one another by a narrow gap and are arranged in parallel so that an electric field having a uniform high intensity in a wide region of ferroelectric layer 115 can be formed and, in response to the applied electric field, ferroelectric layer 115 emits electron beams from its surface exposed in display cell S through electrode windows 313′.

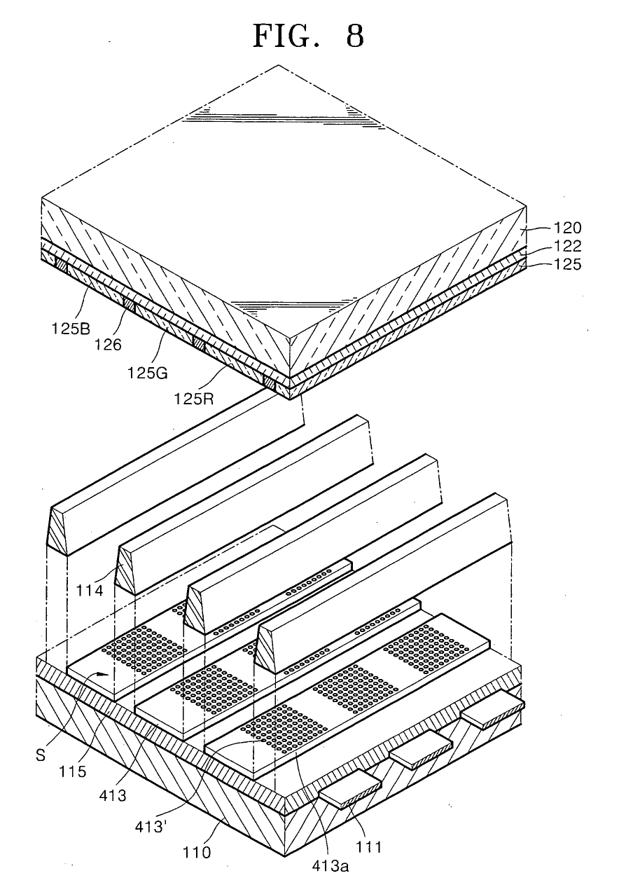

FIG. 8 shows another modified shape of an electrode structure that may be employed according to another embodiment of the present invention. Similar structure and functionality of the flat display panel as stated above will be omitted and only the difference will be described. Referring to FIG. 8, third electrodes 413 and first electrodes 111 are disposed on the top surface and bottom surface of ferroelectric layer 115 placed on first substrate 110, and the first and third electrodes 111 and 413 extend in a direction in which the first and third electrodes 111 and 413 cross one another. A plurality of opening holes 413′ are formed in a region in which third electrodes 413 cross first electrodes 111, and opening holes 413′ are used to form an emission path for electrons emitted due to an interaction between first and third electrodes 111 and 413. Opening holes 413′ may be formed in shapes of circular, square, rectangular, triangle and any possible shapes which do not depart from the spirit and scope of the present invention.

FIGS. 6 through 8 show specific electrode shapes however, the present invention is not limited thereto; rather, the shapes can be construed as various embodiments that can be applied to the present invention.

In the flat display panel constructed according to the present invention, excitation species for light-emission are obtained using a dielectric polarization property of ferroelectrics, the flat display panel may be operated with a low driving voltage and luminous efficiency may be improved as compared to a contemporary display method using a plasma discharge. In addition, by using the principle of field emission using the ferroelectrics together with a plasma discharge, a discharge firing voltage may be reduced and luminous brightness can be increased.

By utilizing a particular memory characteristic of ferroelectrics in which a polarization state is maintained even when an external electric field is removed from the circumference of polarized ferroelectrics, the operations are performed sequentially at a predetermined time difference for a data setting operation of selecting display cells in which light-emission is to be performed and an electron emission operation in which electrons are supplied into the display cells, has been performed. Thus, it is very advantageous for a PM driving method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A flat display panel, comprising:
a first substrate and a transparent second substrate facing each other and being spaced apart from each other by a predetermined distance;
a plurality of barrier ribs which are disposed between the first and second substrates and partition a space between the first and second substrates into a plurality of display cells;
a ferroelectric layer which is disposed to face the display cells and is formed of a ferroelectric material that is to be dielectric-polarized according to an external electric field;
a first electrode and a third electrode to which electric fields having opposite polarities are sequentially applied and which induce polarization inversion in the ferroelectric layer placed between the first and third electrodes so that the ferroelectric layer emits electron beams into the display cells;
an excitation gas filled in the display cells that is to be excited by the electron beams; and
a phosphor layer formed in the display cells.

2. The flat display panel of claim 1, in which the ferroelectric layer is disposed on one side of the first substrate and the side of the first substrate faces to the second substrate.

3. The flat display panel of claim 1, in which the first electrodes are disposed on one of surfaces of the ferroelectric layer and third electrodes are disposed on another surface of the ferroelectric layer, and the two surfaces of the ferroelectric layer are opposite to each other.

4. The flat display panel of claim 1, in which the first and third electrodes extend in predetermined directions and the first and third electrodes cross each other.

5. The flat display panel of claim 4, in which, in each display cell, one first electrode and a pair of third electrodes cross one another.

6. The flat display panel of claim 5, in which the pair of third electrodes extend in parallel and are spaced apart from each other by a predetermined distance and the ferroelectric layer is exposed from gaps between the pair of the third electrodes in the discharge cells.

7. The flat display panel of claim 4, in which, in each display cell, one first electrode and one third electrode cross each other.

8. The flat display panel of claim 4, in which a plurality of electrode windows are formed in portions of the third electrode that crosses the first electrode.

9. The flat display panel of claim 8, in which the electrode windows extend in a lengthwise direction on the third electrode.

10. The flat display panel of claim 4, in which a plurality of opening holes are formed in portions of the third electrode that crosses the first electrode.

11. The flat display panel of claim 1, in which the ferroelectric layer is disposed on one surface of the first substrate and the surface of the first substrate faces to the second substrate; and
a second electrode that forms an acceleration electric field is disposed on one surface of the second substrate to accelerate electrons emitted from the ferroelectric layer and the one surface of the second substrate faces to the first substrate.

12. The flat display panel of claim 1, in which electrons emitted from the ferroelectric layer have an energy level that is higher than an energy needed to excite the excitation gas and lower than an energy needed to ionize the excitation gas.

13. The flat display panel of claim 1, in which the phosphor layer is disposed on the second substrate.

14. The flat display panel of claim 13, in which the second electrode, for accelerating electrons emitted from the ferroelectric layer, is disposed on one surface of the second substrate and the phosphor layer is disposed to cover the second electrode, and the one surface of the second substrate faces to the first substrate.

15. The flat display panel of claim 1, in which the excitation gas comprises xenon (Xe).

16. The flat display panel of claim 1, in which a black matrix is formed between a plurality of different color phosphor layers of the phosphor layers and said black matrix has an excellent light-absorbing rate to absorb external light and maintain a high contrast ratio.

17. A method of driving the flat display panel of claim 1, the method comprising:
applying a positive (+) electric field and a negative (−) electric field to the first electrode and the third electrode, respectively, to induce dielectric polarization in the ferroelectric layer and to accumulate field-emitted electrons on the surface of the ferroelectric layer; and
applying an electric field, having an opposite polarity to a polarity used in the accumulating of the electrons, between the first electrode and the third electrode so as to induce polarization inversion in the ferroelectric layer and to emit electrons accumulated on the surface of the ferroelectric layer into the display cells.

18. The method of claim 17, further comprising removing the electric fields applied to the first electrode and the third electrode and sustaining electrons accumulated by the remaining polarization of the ferroelectric layer, between the accumulating of the electrons and the emitting of the electrons.

19. A method of driving a flat display panel, the method comprising:
applying an electric field between first electrodes and third electrodes of the flat display panel respectively, to induce dielectric polarization in a ferroelectric layer of the flat display panel and to accumulate field-emitted electrons on the surface of the ferroelectric layer;
removing the electric field applied between the first electrodes and the third electrode and sustaining accumulated field-emitted electrons by the remaining polarization of the ferroelectric layer; and
applying an electric field, having an opposite electric field polarity to a polarity initially used to accumulate the field-emitted electrons, between the first electrodes and the third electrodes to induce polarization inversion in the ferroelectric layer and to emit electrons accumulated on the surface of the ferroelectric layer into the display cells.
